(19) United States
(12) Patent Application Publication
(10) Pub. No.: US 2009/0076687 A1
(43) Pub. Date: Mar. 19, 2009

(54) POSITION DETECTION ARRANGEMENT FOR A MOVEABLE FUNCTIONAL ELEMENT WHICH CAN BE POSITIONED MOTOR-DRIVEN IN A MOTOR VEHICLE

(75) Inventors: Crina ENACHE, Bloomfield Hills, MI (US); Dave BRESCIAMI, Macomb, MI (US); Oleg SIMKIN, Koeln (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: BROSE SCHLIESSSYSTEME GMBH & CO. KG, Wuppertal (DE)

(21) Appl. No.: 11/857,676

(22) Filed: Sep. 19, 2007

(51) Int. Cl. G05D 3/00; G06F 7/00

(52) U.S. Cl. 701/49; 701/36

(57) ABSTRACT

A position detection arrangement for a functional element (1) which can be positioned motor-driven in a motor vehicle, a drive arrangement (2) being coupled via a drive train (3) to the functional element (1) and the functional element (1) thus being positionable by a motor (4), there being a measuring unit (5) which is assigned to the drive train (3) and which includes a sensor unit (6) and a gearing with a drive side and a driven side, the drive side being assigned to the drive train (3) and the driven side being assigned to the sensor unit (6). It is suggested that the gearing is realized as a tumble gearing (7) with a tumbler gear (8) and a ring gear (9).

### BACKGROUND OF THE INVENTION

1. Field of the Invention

This invention relates to a position detection arrangement for a functional element which can be positioned motor-driven in a motor vehicle, a drive arrangement being coupled via a drive train to the functional element and the functional element thus being positionable by a motor, there being a measuring unit which is assigned to the drive train for detecting the position of the functional element, wherein the measuring unit comprises a sensor unit and a gearing with a drive side and a driven side, the drive side being assigned to the drive train and the driven side being assigned to the sensor unit. Furthermore the invention relates to a drive unit in a motor vehicle for a positionable functional element with a drive arrangement for motorized positioning of the functional element and a position detection arrangement for detecting the position of the functional element of the type indicated above. The invention also relates to a functional unit with above noted positionable functional element.

2. Description of Related Art

The expression “functional element which can be positioned” should be understood comprehensively here. Accordingly, it includes in general positioning elements in a motor vehicle as well as closure elements like a tailgate, a rear cover, a hood, a cargo space flap, a side door—also a sliding door—and a lifting roof of a motor vehicle. Furthermore windows, mirrors or vehicle seats which can be positioned by a motor are included.

In the course of increasing the comfort of modern motor vehicles, motorized positioning of functional elements, for example the tailgate of a motor vehicle, is acquiring increasing importance. For this purpose, there is a drive arrangement which is coupled via a drive train to the respective functional element.

A known drive arrangement for a tailgate (German utility model DE 20 2005 000 559 U1) has two spindle drives which are coupled, on the one hand, to the body of the motor vehicle, and on the other hand, to the tailgate. The two spindle drives are located on opposite sides of the tailgate.

Another known drive arrangement for a tailgate (German utility model DE 20 2004 016 543 U1 and corresponding US application 2006/0108959) is equipped with a push rod drive, the push rod being coupled to a deflection lever which is connected to the tailgate.

In these drive arrangements, the control of the motorized positioning of the functional element acquires special importance. For this purpose, there is a control means which, based on the absolute position of the functional element, sends suitable control signals to the drive arrangement. Here “absolute position” means an indication which provides information about the actual position of the functional element without further computation. In a tailgate this is, for example, an angle indication which is referenced to the part of the body which can not be positioned. In a broad sense an information about reaching one of the end of travel positions of the tailgate is also included in the expression “absolute position”.

It is apparent that the control of motorized positioning can only be as good as the position data present in the control means about the current absolute position of the functional element. The position detection arrangement under consideration is used to determine this position data.

The known position detecting arrangement (German patent application DE 101 45 711 B4 and corresponding U.S. Pat. No. 6,590,357) underlying the invention is equipped with two incremental rotary transducers. In this connection, one rotary transducer is used for detecting the position of the positionable functional element. This detecting takes place by counting the pulses produced by the incremental rotary transducer.

The second rotary transducer generates pulses which are offset in phase to the pulses of the first rotary transducer. The rotary transducer signals of the second rotary transducer are used solely for determining the current position direction of the functional element.

The problem of the known position detection arrangement is, first of all, the fact that the accuracy which can be achieved with pulse counting is comparatively low. In addition, the control engineering effort to implement it is comparatively high. Finally, in these systems problems often occur in an emergency, for example, when the voltage supply fails. If the absolute position of the functional element is specifically not stored, when the functional element is restarted, there is no longer any information about its absolute position. Then, complex referencing is necessary.

Furthermore, it is pointed out, that, for detection of the absolute position of the functional element, rotary transducers which are made as angle encoders are used. These angle encoders produce rotary transducer signals which are coded depending on the angular position and which, for themselves, provide information about the absolute position. These angle encoders are used as single-turn angle encoders and as multi-term angle encoders. In a single-term angle encoder, the rotary transducer signals periodically repeat after one complete revolution. In a multi-term angle encoder, there is coding of the absolute position over several turns.

The use of angle encoders is also known from the field of tailgates and rear covers of motor vehicles (German patent application DE 199 44 554 A1). The disadvantage in angle encoders is always the high costs. One example of this is shown by German patent DE 33 42 940 C2 and corresponding U.S. Pat. No. 4,712,088.

### SUMMARY OF THE INVENTION

A primary object of the invention is to embody and develop the known position detection arrangement such that detection of the absolute position of the functional element can be achieved with high operating reliability and compact construction.

The aforementioned object is achieved in a position detection arrangement of the initially mentioned type in which the gearing of the measuring unit is constructed as a tumble gearing. Such tumble gearing can be constructed in a considerable compact design without leading to high costs. Also the gear ratio may easily extend the value of 1:50, which in the present case means, that 50 revolutions on the drive side of the tumble gearing lead to one revolution on the driven side of the tumble gearing. This again means that the sensor unit assigned to the driven side has only to be designed with a sensor range of one revolution while the range of movement of the respective element of the drive train may arbitrarily chosen.

The gear ratio of the proposed tumble gearing is provided by a special engagement between a tumbler gear with a ring gear, wherein the tumbler gear is realized as a spur gear being arranged within the ring gear and having an addendum circle diameter smaller than the addendum circle diameter of the ring gear. During movement of the functional element the tumbler gear is meshing with the ring gear while the tumbler gear is revolving around its geometrical axis and the geometrical axis of the tumbler gear is revolving around the geometrical axis of the ring gear. The advantage of this arrangement in view of installation space is the fact that all components are basically arranged around the geometrical axis of the ring gear.

The above noted constructional design is of special advantage when at least one drive of the drive arrangement is a spindle drive with a spindle-spindle-nut gear train and wherein the drive side of the tumble gearing is assigned to the spindle. This is especially true when the geometrical axis of the ring gear is aligned to the geometrical axis of the spindle such that the tumble gearing and the spindle-spindle-nut gear train may be arranged in series which leads to extraordinary advantages in view of installation space.

According to a second teaching which acquires independent importance, a drive unit for a positionable functional element is provided with the described drive arrangement for motorized positioning of the functional element and the described position detection arrangement for detecting the position of the functional element.

According to a third teaching which likewise acquires independent importance, a functional unit in a motor vehicle is provided with the described functional element, the described drive arrangement and the described position detection arrangement for detecting the position of the functional element.

The invention is explained in detail below with respect to the embodiments shown in the accompanying.

### BRIEF DESCRIPTION OF THE DRAWINGS

FIG. 1 is a schematic side view of the rear of a motor vehicle with a drive arrangement with the tailgate opened,

FIG. 2 shows the drive arrangement of the motor vehicle shown in FIG. 1 with a position detection arrangement in accordance with the invention in a view from the interior of the motor vehicle, encircled details being broken out and enlarged,

FIG. 3 shows a position detection arrangement in accordance with the invention in the non-installed state,

FIG. 4 shows the position detection arrangement according to FIG. 3 in a disassembled state with the position detection arrangement body on the left side and the position detection arrangement cover on the right side,

FIG. 5 shows another embodiment of a position detection arrangement in accordance with the invention in views according to FIG. 4,

FIG. 6 shows another embodiment of a position detection arrangement in accordance with the invention in views according to FIG. 4,

FIG. 7 shows another embodiment of a position detection arrangement in accordance with the invention in views according to FIG. 4,

FIG. 8 shows another embodiment of a position detection arrangement in accordance with the invention in views according to FIG. 4, and

FIG. 9 shows another embodiment of a position detection arrangement in accordance with the invention in vies according to FIG. 4.

### DETAILED DESCRIPTION OF THE INVENTION

The position detection arrangement in accordance with the invention can be used for all possible functional elements 1, especially closure elements in a motor vehicle. For this purpose reference is made to the listing of applications in the introductory part of the description, the application to tailgates and side doors being emphasized. The drawings relate to the use of the position detection arrangement for a functional element 1 which is made as a tailgate. This should not be interpreted as limiting. All aspects pointed out in the following description concerning the tailgate 1 completely apply for all other functional elements 1 noted above.

The tailgate 1 shown in the drawings can be positioned motor-driven. For this a drive arrangement 2 is coupled via a drive train 3 to the tailgate 1 for enabling the tailgate 1 to be positioned by a motor 4.

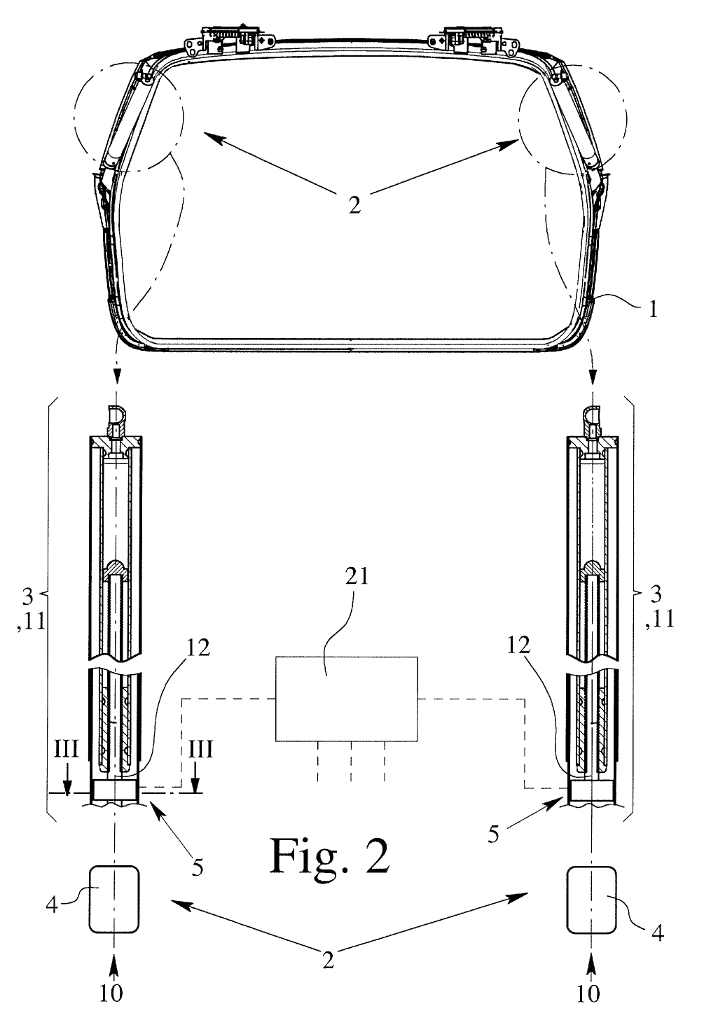

In order to detect the absolute position of the tailgate 1 a position detection arrangement is proposed. Concerning the broad understanding of the expression “absolute position” reference is made to the general part of the description. For describing the proposed position detection arrangement only the left part of the drive arrangement 2 shown in FIG. 2 is relevant at that point.

The position detection arrangement comprises a measuring unit 5 which is assigned to the drive train 3 for detecting the absolute position of the tailgate 1. The measuring unit 5 comprises a sensor unit 6 and a tumble gearing 7 with a drive side 7a and a driven side 7b. The drive side 7a is assigned to the drive train 3 and the driven side 7b is assigned to the sensor unit 6. The preferred coupling of the measuring unit 5 to the drive train 3 will be described at a later point.

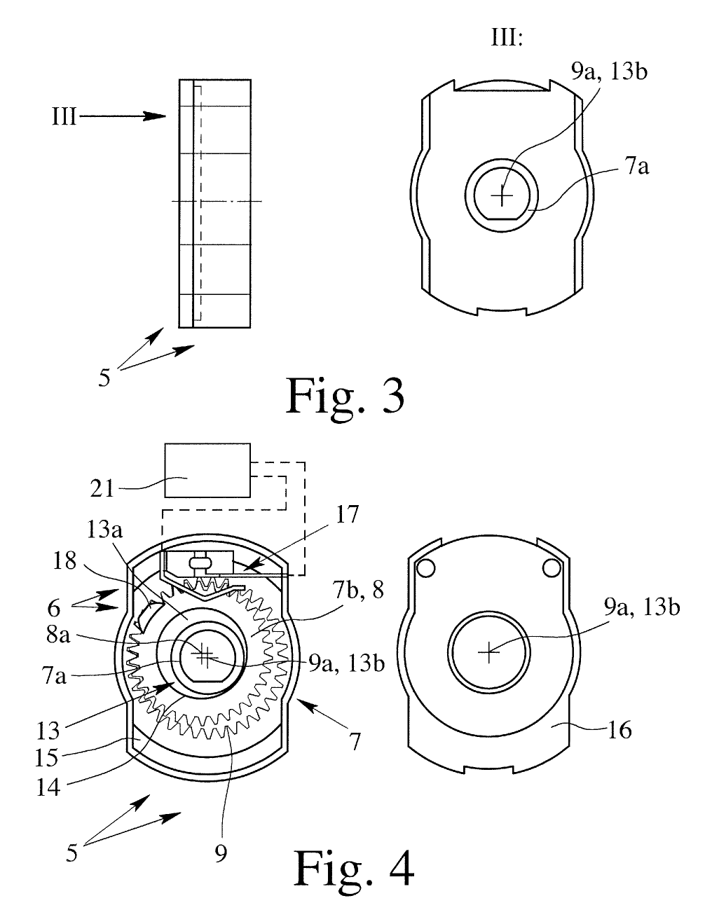

FIG. 3 shows the measuring unit 5 in a side view (left) and in a front view (right). Details of the measuring unit 5 will be given in the following.

The tumble gearing 7 provides a very compact arrangement. This is mainly because the gear ratio of the tumble gearing 7 is provided by a tumbler gear 8 realized as a spur gear being arranged within a ring gear 9, wherein the tumbler gear 8 has an addendum circle diameter smaller than the addendum circle diameter of the ring gear 9. This may be taken from FIG. 4 that shows the housing 15 of the measuring unit 5 including the tumble gearing 7 (left) and the cover 16 of the measuring unit 5 (right). Both illustrations in FIG. 4 are front views of the inner side of the housing 15 and the cover 16.

A movement of the tailgate 1 produces a movement of the tumbler gear 8 via the coupling between the drive train 3 and the measuring unit 5 to be discussed. During such movement of the tailgate 1 the tumbler gear 8 is meshing with the ring gear 9 while the tumbler gear 8 is turning around its geometrical axis 8a and while the geometrical axis 8a of the tumbler gear 8 is revolving around the geometrical axis 9a of the ring gear 9. How this tumbler movement of the tumbler gear 8 is realized will be discussed later on.

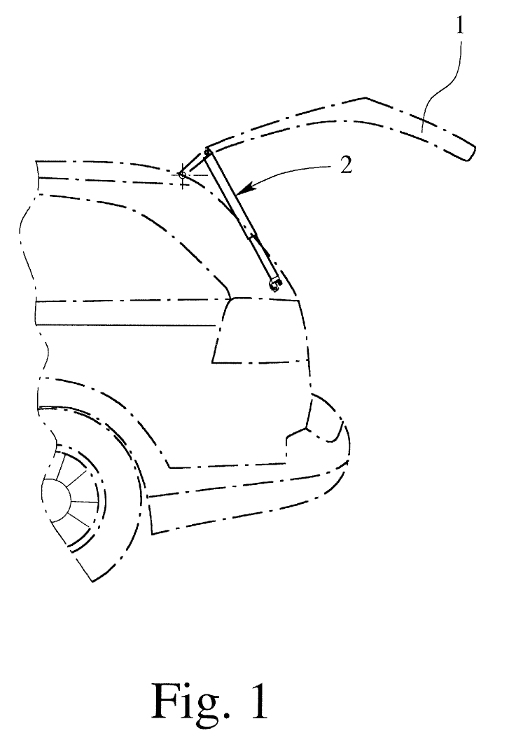

It has been pointed out already that the functional element 1 here is a closure element of a motor vehicle, preferably a tailgate 1 of a motor vehicle. FIGS. 1 and 2 show that the above noted drive arrangement 2 has two drives 10 each with a motor 4 and a downstream gear train 11 which acts via the drive train 3 on the tailgate 1. In dependence of the construction of the functional element 1 it can be advantageous to have only one drive 10 or even more than two drives 10.

According to FIG. 2 it is preferred that at least one drive 10 is a spindle drive with a spindle-spindle nut gear train 11 and wherein the drive side 7a of the tumble gearing 7 is assigned to the spindle 12.

According to the illustration in FIG. 2 it is further apparent that in the shown preferred embodiment the geometrical axis 9a of the ring gear 9 is aligned to the geometrical axis 12 of the spindle 12. This leads to an extraordinary compact structure.

The overall goal of integrating the tumble gearing 7 into the measuring unit 5 is to have a speed reduction concerning the angular speed on the drive side 7a and the angular speed on the driven side 7b of the tumble gearing 7. With an appropriate design of the tumbler gear 8 and the ring gear 9 it is then possible to use a sensor unit 6 which has a sensor range of less than 360°, which leads to low sensor costs.

There are a number of possible ways to realize the tumbler movement of the tumbler gear 8. According to a preferred embodiment the tumble gearing 7 comprises an eccentric 13 with a circular eccentric body 13a arranged eccentrically relative to a geometrical axis 13b of the eccentric 13, the geometrical axis 13b of the eccentric 13 being aligned to the geometrical axis 9a of the ring gear 9. The tumbler gear 8 now has a bore 14 rotatably receiving the eccentric body 13a. Simply spoken, the eccentric 13 holds the tumbler gear 8 in meshing engagement with the ring gear 9.

Various ways of operation of the tumble gearing 7 are possible. Preferably one of the eccentric 13, tumbler gear 8 and ring gear 9 is assigned to the drive train 3 of the tailgate 1, wherein another of the eccentric 13, tumbler gear 8 and ring gear 9 is assigned to the sensor unit 6. In the preferred embodiments shown in the drawings the eccentric 13 is assigned to the drive train 3 of the tailgate 1 and the tumbler gear 8 is assigned to the sensor unit 6.

Further it is preferred that one of the ring gear 9 and the eccentric 13 is fixedly arranged. In the preferred embodiments shown in the drawings the ring gear 9 is fixedly arranged. A robust and low cost solution for this fixedly arrangement is integrating the ring gear 9 into the housing 15 of the measuring unit 5.

It is apparent from FIGS. 1 and 2 that the tailgate 1 may be moved by turning the spindle 12 with motor 4. The spindle 9 is in engagement with the eccentric 13 and at least partly extends through the eccentric 13. This may be taken from FIGS. 2, 3 and 4.

When the spindle is driven by the motor 4 to make a rotating movement the eccentric 13 follows this movement around its geometrical axis 13b. This forces the tumbler gear 8 to mesh with the ring gear 9 while rotating on the eccentric body 13a of the eccentric. This again causes the above noted revolving of the tumbler gear 8 around its geometrical axis 8a and also the revolving of the geometrical axis 8a of the tumbler gear 8 around the geometrical axis 9a of the ring gear 9.

When tracking one specific point at the circumference of the tumbler gear 8 it comes apparent that this point follows a path that is a superposition of a circle with a cycloid.

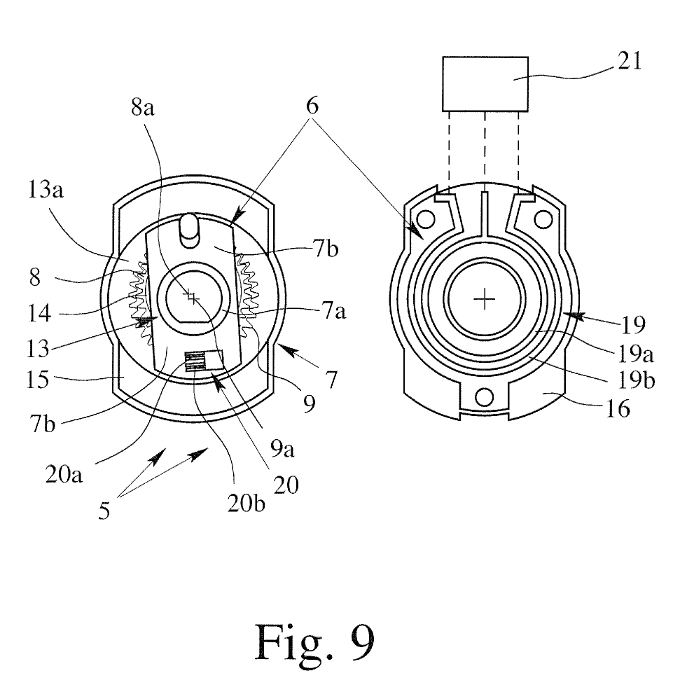

The above noted, quite complicated path in most cases leads to special requirements on the sensor unit. In one preferred embodiment, however, it leads to a rather simple structure of the sensor unit. This preferred embodiment is shown in FIG. 9.

In FIG. 9a follower 8b is realized that is revolvable around the geometrical axis 7a of the ring gear 7. Depending on the constructional realization the follower 8b may be in sliding engagement with the spindle 12 or with the eccentric 13. In any case, however, the follower 8b is revolvable around the geometrical axis 7a of the ring gear 7 as noted above. The follower 8b engages the tumbler gear 8 such that the tumbling movement of the tumbler gear 8 produces a circular movement of the follower 8b. The eccentric 13 is assigned to the drive train 3 of the talegate 1 while the follower 8b is assigned to the sensor unit 6. However, it can also be advantageous that the ring gear 7, and not the eccentric 13, is assigned to the drive train 3 of the talegate 1.

In the preferred embodiment shown in FIG. 9 for producing the circular movement of the follower 8b the tumbler gear 8 comprises a pin 8c that is arranged eccentrically relative to the geometrical axis 7a of the tumbler gear 7 and that is in engagement with a corresponding slot 8d in the follower 8b. There are other constructional alternatives possible.

It becomes clear from the above that the follower 8b is driven by the tumbler gear 8 but, in the end, makes a circular movement that is “easy to handle”.

FIGS. 4 to 9 show different preferred alternatives for the realization of the sensor unit 6.

According to FIG. 4 the sensor unit 6 is realized as a switching unit and comprises a switch 17 and at least one cam 18 assigned to the switch 17. Here, the switch 17 is fixedly arranged on the housing 15 and the cam 18 is arranged on the tumbler gear 8 such that during movement of the tailgate 1 the cam 18 comes into switching engagement with the switch 17. This preferred embodiment is the most simple alternative for measuring the absolute position of the tailgate 1. The cam 18 travels along the above noted path such that it comes into switching engagement with the switch 17 when the tailgate 1 reaches its opening and/or closing position. It is possible here to realize two or more cams 18 if the range of movement of the tailgate 1 does not correspond to a sensor range of about 360°.

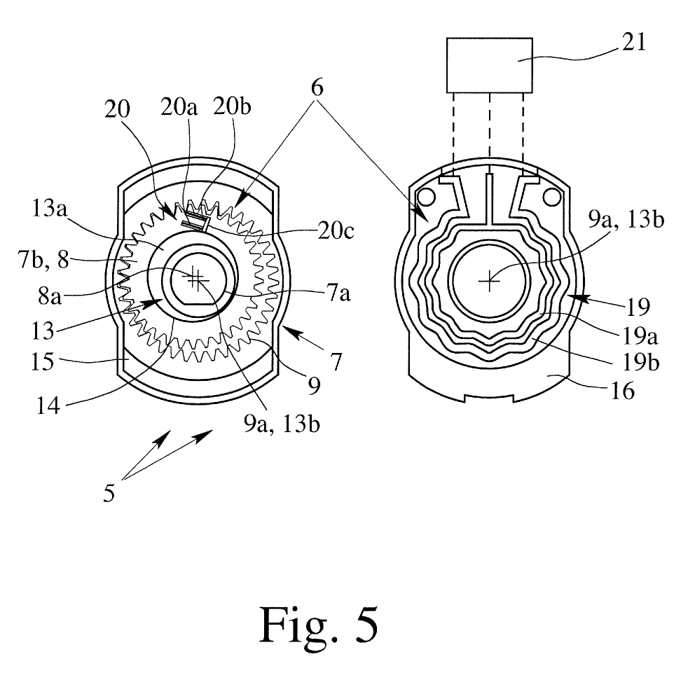

The preferred embodiment shown in FIG. 4 is nothing else than an end of travel switch for the tailgate 1. The main advantage is the low number of parts and the very compact design. It is further of considerable advantage that the sensor unit 6 may be integrated completely into the housing 15 which is closed by the cover 16 such that the sensor unit 6 is protected from dirt and moisture. Those advantages apply also to the embodiments shown in FIGS. 5 to 9.

It is to be emphasized that realizing the sensor unit 6 as a simple switching unit may be applied to the construction shown in FIG. 9 comprising the follower 8b. Then the switch is fixedly arranged and the cam is arranged on the follower 8b such that during movement of the talegate 1 the at least one cam comes into switching engagement with the switch as noted above. The advantage is that the cam now makes a circular movement which leads to a simple construction of the sensor unit 6.

The further preferred embodiments shown in FIGS. 5 to 9, however, allow not only the “binary” detection of the tailgate 1 reaching the opening position or the closed position but also allow a continuous detection of any position in between those two end of travel positions. For this the sensor unit 6 comprises a sensor track 19 arranged basically around the geometrical axis 9a of the ring gear 9 and a sliding device 20 always staying in alignment with the sensor track 19 for detecting the position of the sliding device 20 on the sensor track 19. The best known arrangement with a sensor track 19 with assigned sliding device 20 is a rotational potentiometer, which will be discussed later. Preferably, one of the sensor track 19 and the sliding device 20 is arranged on the tumbler gear 8 or, if so, on the follower 8b, and the other of the sensor track 19 and the sliding device 20 is fixedly arranged. This will be described in detail for each embodiment separately.

It is to be noted that the expression “sliding device” is to be understood in a broad sense. It does not only include an arrangement in which the sliding device actually contacts the sensor track 19. It also includes arrangements where the sliding device 20 is assigned to the sensor track 19 in a contact-free manner.

In the preferred embodiments shown in FIGS. 5 to 8 the sensor track 19 is designed such that the sliding device 20 is always staying in alignment with the sensor track 19. This is necessary when the radial position of the sliding device 20 relative to the geometrical axis 8a, 9a of one of the tumbler gear 8 and the ring gear 9 is fixed. This is true due to the tumbler movement of the tumbler gear 8.

One could also say that the design of the sensor track 19 in the embodiments shown in FIGS. 5 to 8 is such that it compensates the tumbler movement of the tumbler gear 8. In accordance with the above noted tumbler movement of the tumbler gear 8 the design of the sensor track 19 is a superposition of a circle design with a cycloid-like design which as above noted compensates the tumbler movement of the tumbler gear 8 such that the sliding device 20 is always staying in alignment with the sensor track 19. If the sensor track 19 is arranged on the tumbler gear 8 the circle design is aligned with the geometrical axis 8a of the tumbler gear 8. If the sensor track 19 is fixedly arranged the circle design is aligned with the geometrical axis 9a of the ring gear 9.

It has been noted above that the realization of a follower 8b shown in FIG. 9 leads to a very simple design of the sensor track 19. In particular in the embodiment shown in FIG. 9 the design of the sensor track 19 is a pure circle design which corresponds to the circular movement of the follower 8b. Accordingly the respective circle is aligned with the geometrical axis of the ring gear 7.

FIGS. 5 to 7 and 9 show arrangements with the sensor unit 6 being realized as a potentiometer unit and wherein the sensor track 19 is constructed as a resistive track 19 and the sliding device 20 is constructed as a sliding contact 20. For the realization of such a potentiometer unit 6 various alternatives are possible.

In those embodiments the resistive track 19 comprises an inner resistive track 19a and an outer resistive track 19b with respect to the geometrical axis 8a, 9a of one of the tumbler gear 8 and the ring gear 9. Which axis 8a, 9b is applicable here depends on whether the resistive track 19 is arranged on the tumbler gear 8 or is fixedly arranged. According to the existence of an inner resistive track 19a and an outer resistive track 19b in the preferred embodiments shown in FIGS. 5 to 7 and 9 the sliding device 20 comprises a corresponding inner sliding device 20a and a corresponding outer sliding device 20b.

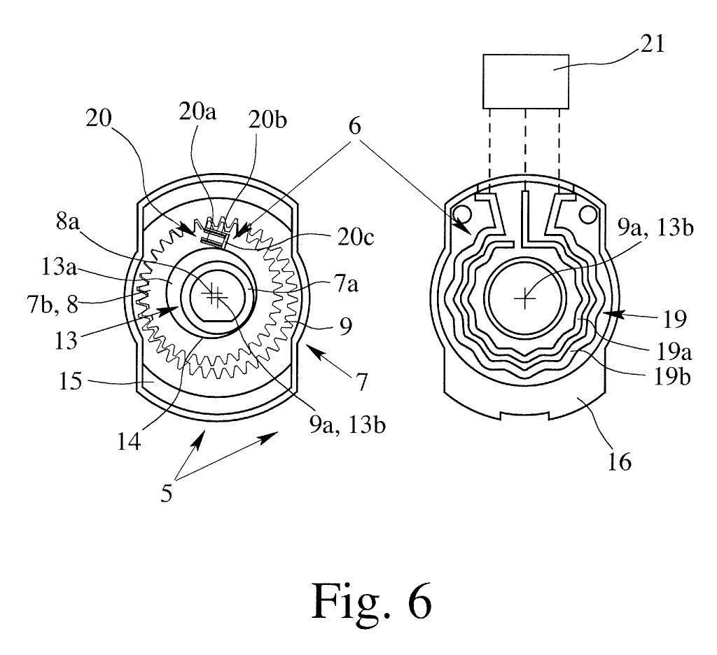

According to the preferred embodiments shown in FIGS. 5 and 6 the inner resistive track 19a and the outer resistive track 19b are electrically separated and the sliding contact 20 shortcuts the inner resistive track 19a and the outer resistive track 19b at its respective position on the resistive tracks 19a, 19b. For this the inner sliding device 20a and the outer sliding device 20b are connected by an electrical bridge 20c.

In order to allow a simple realization of the sliding device 20 it is preferred that the inner resistive track 19a and the outer resistive track 19b are arranged basically in parallel. This is shown in FIGS. 5 to 7.

In the preferred embodiments according to FIGS. 5 and 6 the resistive track 19, in detail the inner resistive track 19a and the outer resistive track 19b, is/are connected to a control unit 21. By appropriate application of a measuring voltage it is possible to detect the position of the respective shortcut i.e. the position of the sliding device 20. In dependence of the realization of the resistive track 19 this measurement may simply go back on measuring the resistance between the inner resistive track 19a and the outer resistive track 19b.

Various alternatives for realizing the resistive track 19 are possible. For example it can be advantageous that one of the inner resistive track 19a and the outer resistive track 19b provides an open circuit and wherein the other one of the inner resistive track 19a and the outer resistive track 19b provides a closed circuit. This is shown in FIG. 5 where the inner resistive track 19a provides a closed circuit and the outer resistive track 19b provides an open circuit.

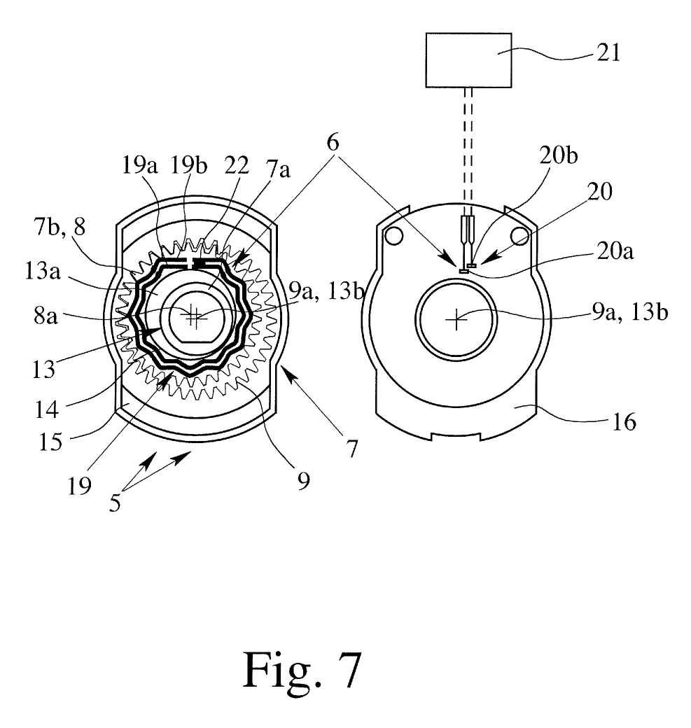

It can also be advantageous that the inner resistive track 19a and the outer resistive track 19b as such provide open circuits. This is shown in FIG. 6. Additionally it may be advantageous that one end of the inner resistive track 19a is electrically connected to the respective end of the outer resistive track 19b by an electrical bridge 22 (FIG. 7). With this arrangement it is again possible to detect the position of the sliding device 20 on the resistive track 19 by a simple resistive measurement via the control unit 21.

In the embodiments shown in FIGS. 5 to 7 and 9 it is preferred that the resistive track 19 is constructed as a printed circuit board track. This allows an automized and low cost production of the measuring unit 5.

It may be pointed out that in the embodiments shown in FIGS. 5 and 6 the resistive track 19 is arranged on the cover 16 and the sliding device 20 with electrical bridge 20c is arranged on the tumbler gear 8. This is advantageous as a connection to the control unit 21 is necessary only to the resistive track 19 and not to the sliding device 20. The sliding device 20 can therefore freely follow the tumbler movement of the tumbler gear 8.

A different situation is shown in FIG. 7. Here the resistive track 19 is arranged on the tumbler gear 8 and the sliding device 20 is arranged on the cover 16. This is advantageous as the sliding device 20 does not only serve as a shortcut device. The sliding device 20 is connected to the control unit 21 for resistive measurement. In this arrangement the sliding device 20, and not the resistive track 19 is connected to the control unit 21 such that the resistive track 19, can freely follow the tumbler movement of the tumbler gear 8.

It may be pointed out that the embodiment shown in FIG. 9 corresponds to the embodiment shown in FIG. 5 as far as the realization of the sensor unit 6 is concerned. However, all discussed preferred embodiments as well as all embodiments to be discussed concerning possible realizations of the sensor unit 6 are applicable to the construction with follower 8b shown in FIG. 9. Reference is made to the corresponding parts of the description.

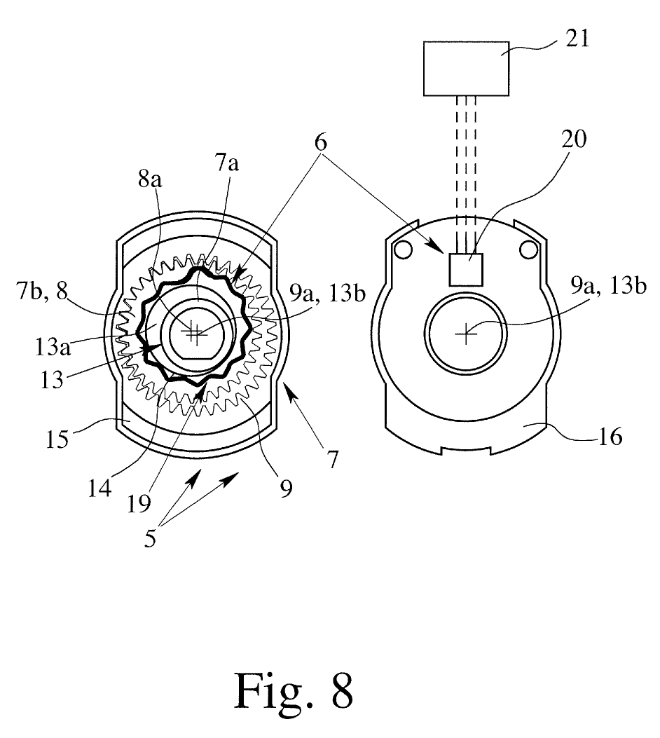

Another preferred realization of the above noted concept with sensor track 19 and sliding device 20 is shown in FIG. 8. Here the sliding device 20 is assigned to the sensor track 19 in a contact-free manner. Preferably, the sensor unit 6 is realized as a hall sensor unit wherein the sensor track 19 is constructed as a magnetic track and wherein the sliding device 20 is constructed as a hall sensor. Due to the contact-free functioning of the hall sensor the sliding device does not actually contact the sensor track 19. Reference is made to the above noted wide meaning of the expression “sliding device”.

First it is to be understood that the sensor signal produced by the hall sensor 20 differs with the hall sensor 20 coming out of perfect alignment with the magnetic track 19. Therefore the design of the magnetic track 19 preferably is a superposition of a spiral design with a cycloid-like design, such that the tumbler movement of the tumbler gear 8 is compensated and at the same time during movement of the tailgate 1 the hall sensor 20 continuously comes out of perfect alignment with the magnetic track 19. With this it is possible to detect the sliding device 20 on the magnetic track 19 based on the signals produced by the hall sensor 20. Accordingly the hall sensor 20 is again connected to the control unit 21.

In the preferred embodiment shown in FIG. 8 the sensor track 19 is arranged on the tumbler gear 8 while the hall sensor 20 is arranged on the cover 16. This is advantageous as only the hall sensor 20 is to be connected to the control unit 21 such that the magnetic track 19 may freely follow the tumbler movement of the tumbler gear 8.

As a matter of clarification it may finally be pointed out that in all preferred embodiments shown in the drawings the drive side 7a of the tumble gearing 7 is provided by the eccentric 13 and the driven side 7b of the tumble gearing 7 is provided by the tumbler gear 8. It has been noted above that variations concerning the way of operation of the tumble gearing 7 are possible.

According to a second teaching which acquires independent importance, a drive unit for a positionable functional element 1 in a motor vehicle, comprising a drive arrangement 2 and a position detection arrangement is encompassed by the invention.

According to a third teaching which likewise acquires independent importance, moreover a functional unit in a motor vehicle with the described functional element 1, the described drive arrangement 2 and the described position detection arrangement is also encompassed by the invention.

All aforementioned statements on advantages and versions apply accordingly to the two other teachings. This applies especially to possible versions of the functional element 1 which were explained in the introductory part of the description.

What is claimed is:

1. Position detection arrangement for a moveable functional element which can be positioned motor-driven in a motor vehicle, wherein a drive arrangement is coupled via a drive train to the functional element for enabling the functional element to be positioned by a motor, wherein a measuring unit is assigned to the drive train for detecting the absolute position of the functional element, wherein the measuring unit comprises a sensor unit and a tumble gearing with a drive side and a driven side, the drive side being assigned to the drive train and the driven side being assigned to the sensor unit, wherein the gear ratio of the tumble gearing is provided by a tumbler gear realized as a spur gear being arranged within a ring gear and having an addendum circle diameter smaller than the addendum circle diameter of the ring gear, wherein during movement of the functional element the tumbler gear is meshing with the ring gear while the tumbler gear is revolving around its geometrical axis and the geometrical axis of the tumbler gear is revolving around the geometrical axis of the ring gear.

2. Position detection arrangement according to claim 1, wherein the functional element is a closure element of a motor vehicle.

3. Position detection arrangement according to claim 1, wherein the functional element is a tailgate of a motor vehicle.

4. Position detection arrangement according to claim 1, wherein the drive arrangement has at least one drive with a motor and a downstream gear train which acts via the drive train on the functional element.

5. Position detection arrangement according to claim 4, wherein at least one drive is a spindle drive with a spindle-spindle nut gear train and wherein the drive side of the tumble gearing is assigned to the spindle.

6. Position detection arrangement according to claim 5, wherein the geometrical axis of the ring gear is aligned with the geometrical axis of the spindle.

7. Position detection arrangement according to claim 1, wherein the tumble gearing provides a speed reduction concerning the angular speed on the drive side and the angular speed on the driven side.

8. Position detection arrangement according to claim 1, wherein the tumble gearing comprises an eccentric with a circular eccentric body arranged eccentrically relative to a geometrical axis of the eccentric, the geometrical axis of the eccentric being aligned to the geometrical axis of the ring gear, wherein the tumbler gear has a bore rotatably receiving the eccentric body and wherein the eccentric holds the tumbler gear in meshing engagement with the ring gear.

9. Position detection arrangement according to claim 8, wherein one of the eccentric, tumbler gear and ring gear is assigned to the drive train of the functional element and wherein another of the eccentric, tumbler gear and ring gear is assigned to the sensor unit.

10. Position detection arrangement according to claim 9, wherein one of the ring gear and the eccentric is fixedly arranged.

11. Position detection arrangement according to claim 8, wherein a follower is realized that is revolvable around the geometrical axis of the ring gear, wherein the follower engages the tumbler gear such that the tumbler movement of the tumbler gear produces a circular movement of the follower, and wherein one of the eccentric and the ring gear is assigned to the drive train of the functional element and wherein the follower is assigned to the sensor unit.

12. Position detection arrangement according to claim 11, wherein for producing the circular movement of the follower the tumbler gear comprises a pin that is arranged eccentrically in view of the geometrical axis of the tumbler gear and that is in engagement with a corresponding slot in the follower.

13. Position detection arrangement according to claim 1, wherein the sensor unit is realized as a switching unit and comprises a switch and at least one cam assigned to the switch and wherein the switch is fixedly arranged and the cam is arranged on the tumbler gear such that during movement of the functional element the at least one cam comes into switching engagement with the switch.

14. Position detection arrangement according to claim 11, wherein the sensor unit is realized as a switching unit and comprises a switch and at least one cam assigned to the switch and wherein the switch is fixedly arranged and the cam is arranged on the follower such that during movement of the functional element the at least one cam comes into switching engagement with the switch.

15. Position detection arrangement according to claim 1, wherein the sensor unit comprises a sensor track arranged basically around the geometrical axis of the ring gear and a sliding device always staying in alignment with the sensor track for detecting the position of the sliding device on the sensor track.

16. Position detection arrangement according to claim 15, wherein one of the sensor track and the sliding device is arranged on the tumbler gear and the other of the sensor track and the sliding device is fixedly arranged.

17. Position detection arrangement according to claim 15, wherein one of the sensor track and the sliding device is arranged on the follower and the other of the sensor track and the sliding device is fixedly arranged.

18. Position detection arrangement according to claim 15, wherein the radial position of the sliding device relative to the geometrical axis of the ring gear is fixed and wherein the sensor track is designed such that the sliding device is always staying in alignment with the sensor track.

19. Position detection arrangement according to claim 18, wherein the design of the sensor track is a superposition of a circle design with a cycloid-like design which compensates the tumbler movement of the tumbler gear such that the sliding device is always staying in alignment with the sensor track.

20. Position detection arrangement according to claim 15, wherein the design of the sensor track is as circle design which corresponds to the circular movement of the follower.

21. Position detection arrangement according to claim 15, wherein the sensor unit is realized as a potentiometer unit and wherein the sensor track is constructed as a resistive track and the sliding device is constructed as a sliding contact.

22. Position detection arrangement according to claim 21, wherein the resistive track comprises an inner resistive track and an outer resistive track, with respect to the geometrical axis of one of the tumbler gear and the ring gear.

23. Position detection arrangement according to claim 22, wherein the inner resistive track and the outer resistive track are electrically separated and the sliding contact shortcuts the inner resistive track and the outer resistive track at its respective position on the resistive tracks.

24. Position detection arrangement according to claim 22, wherein the inner resistive track and the outer resistive track are arranged basically in parallel.

25. Position detection arrangement according to claim 22, wherein one of the inner resistive track and the outer resistive track provides an open circuit and wherein the other one of the inner resistive track and the outer resistive track provides a closed circuit.

26. Position detection arrangement according to claim 22, wherein both the inner resistive track and the outer resistive track as such provide open circuits.

27. Position detection arrangement according to claim 26, wherein one end of the inner resistive track is electrically connected to the respective end of the outer resistive track.

28. Position detection arrangement according to claim 21, wherein the resistive track is constructed as a printed circuit board track.

29. Position detection arrangement according to claim 15, wherein the sensor unit is realized as a hall sensor unit and wherein the sensor track is constructed as a magnetic track and wherein the sliding device is constructed as a hall sensor.

30. Position detection arrangement according to claim 29, wherein the design of the magnetic track is a superposition of a spiral design with a cycloid-like design, such that the tumbler movement of the tumbler gear is compensated and at the same time during movement of the functional element the hall sensor continuously comes out of perfect alignment with the magnetic track.

31. Drive unit for a positionable functional element in a motor vehicle, comprising a drive arrangement for motorized positioning of the functional element and a position detection arrangement for detecting the position of the functional element, wherein the drive arrangement, in an installed state, is coupled via a drive train to the functional element, wherein a measuring unit is assigned to the drive train for detecting the position of the functional element, wherein the measuring unit comprises a sensor unit and a tumble gearing with a drive side and a driven side, the drive side being assigned to the drive train and the driven side being assigned to the sensor unit, wherein the gear ratio of the tumble gearing is provided by a tumbler gear realized as a spur gear being arranged within a ring gear and having an addendum circle diameter smaller than the addendum circle diameter of the ring gear, wherein during movement of the functional element the tumbler gear is meshing with the ring gear while the tumbler gear is turning around its geometrical axis and the geometrical axis of the tumbler gear is revolving around the geometrical axis of the ring gear.

32. Functional unit in a motor vehicle, comprising a functional element which is positioned by a motor, a drive arrangement and a position detection arrangement for detecting the position of the functional element, wherein the drive arrangement is coupled via a drive train to the functional element via which the functional element is positionable by a motor, wherein a measuring unit is assigned to the drive train for detecting the position of the functional element, wherein the measuring unit comprises a sensor unit and a tumble gearing with a drive side and a driven side, the drive side being assigned to the drive train and the driven side being assigned to the sensor unit, wherein the gear ratio of the tumble gearing is provided by a tumbler gear realized as a spur gear being arranged within a ring gear and having an addendum circle diameter smaller than the addendum circle diameter of the ring gear, wherein during movement of the functional element the tumbler gear is meshing with the ring gear while the tumbler gear is turning around its geometrical axis and the geometrical axis of the tumbler gear is revolving around the geometrical axis of the ring gear.
